(19) United States
(12) Patent Application Publication
(10) Pub. No.: US 2013/0342028 A1
(43) Pub. Date: Dec. 26, 2013

(54) Capacitive Charging Power Source for Electrolytic Reactors

(71) Applicants: Greg William Hermann, La Grande, OR (US); David Leslie Winburn, La Grande, OR (US)

(72) Inventors: Greg William Hermann, La Grande, OR (US); David Leslie Winburn, La Grande, OR (US)

(73) Assignee: GLOBALSEP CORPORATION

(21) Appl. No.: 14/005,152

(22) PCT Filed: Mar. 13, 2012
(86) PCT No.: PCT/US12/28928

§ 371 Date: Sep. 13, 2013

Related U.S. Application Data
(60) Provisional application No. 61/465,136, filed on Mar. 14, 2011.

(51) Int. Cl. H02J 1/00

(52) U.S. Cl. CPC H02J 1/00
USPC 307/109

(57) ABSTRACT

Systems and methods utilizing a capacitive charging power source for fluid treatment reactors are disclosed. In an example embodiment, a DC power source charges a capacitor circuit configured to store energy. A switching circuit with an input connected to the capacitor circuit has reversing polarity outputs which provide a pulsed discharge of energy at a frequency with an adjustable duty cycle. An inductive load may be connected to the reversing polarity outputs, and a fluid treatment reactor with at least two electrodes may be connected to the inductive load.

### CROSS REFERENCE TO RELATED APPLICATIONS

The present application claims priority to U.S. Provisional Patent Application No. 61/465,136 filed on Mar. 14, 2011, the entire contents of which are incorporated by reference herein.

### BACKGROUND

The present disclosure relates in general to a power supply arrangement. Particularly, for example, the present disclosure includes a power supply arrangement for an electrolytic reactor used for water treatment applications. It should be appreciated that a fluid treatment reactor, such as an electrolytic reactor or electrochemical reactor requires a suitable power source for operation. Typically, electrolytic reactors used for treatment of fluids such as electrocoagulation, metal ion generation, and other electrolytic and electrochemical processing methods known in the water treatment industry typically include two or more electrodes secured in a vessel and connected to a source of DC power. As the liquid is passed or placed between the electrodes, DC power is applied to the electrodes, thereby creating an electrical potential or charge that causes the intended reaction within the reactor. In the case of electrocoagulation or electro-flocculation, the applied voltage and current causes metal ions to dissolve from the surface of electrodes to coagulate contaminants in the water flowing through the reactor. Although these types of electrolytic technologies have been around for many years, the technology remains inefficient due to high power consumption and high maintenance.

### SUMMARY

The present disclosure provides a new and innovative power supply arrangement, particularly for electrolytic reactor applications, which may include consumable electrodes. In an example embodiment, a DC power source receives an AC input, and a capacitor circuit configured to store energy is continuously charged from the DC power source. A high speed switching circuit with an input connected to the capacitor circuit is configured as an H-bridge with reversing polarity outputs which provide a pulsed discharge of energy at a frequency with an adjustable duty cycle. An inductive load is connected to the reversing polarity outputs, and a fluid treatment reactor with at least two electrodes is connected to the inductive load.

In an example embodiment, a power source for electrolytic and electrochemical reactors includes a capacitor circuit configured to store energy that is charged by a DC power source and a switching circuit. The switching circuit includes independently controlled reversed polarity outputs which provide a pulsed discharge of energy at a frequency with an adjustable duty cycle to a fluid treatment reactor.

In an example embodiment, the power supply arrangement provides capacitive charging of the reactor at a controlled rate of current flow and effectively limits power to that which can be utilized by the cell, significantly reducing overall power consumption, reducing heat being generated, reducing maintenance, and increasing overall performance.

In an example embodiment such as a system configured with an electrolytic reactor having consumable electrodes, a DC power supply with current limit output provides charging of the capacitor circuit to maximum or near maximum charge capacity, followed by discharging the capacitor using a high frequency H-Bridge configured switch arrangement with inductor means on the output of said high speed H-Bridge switch connected to the power input leads of an electrolytic reactor. The frequency and duty cycle of the switch is adjusted to accommodate the electrical resistance of the electrolytic reactor to effectively limit current, while providing sufficient voltage potential to liberate metal ions from electrodes contained within the electrolytic reactor. The high speed H-Bridge switch arrangement enables the output to be of a selectable polarity, whereby the polarity of the high speed switch output switch can be alternated periodically or simultaneously, depending on the application.

In an example embodiment, the power supply arrangement overcomes certain limitations and disadvantages of power supply arrangements of the prior art for applications that involve electrolytic reactors used for water treatment applications. In an example embodiment, operating costs are reduced by efficiently utilizing an electrolytic reactor as a charging capacitor and limiting the flow of unnecessary current, therefore reducing operating costs by improving power efficiency.

In an example embodiment, an electrolytic reactor is capable of treating highly conductive liquids by utilizing a capacitor to store a charge, followed by releasing that charge at high energy pulses while maintaining the voltage required for the reactor to operate. In an example embodiment, electrolytic reactors have the ability to limit thermal energy build-up within the cell by effectively limiting current flow through high intensity train of pulses.

In an example embodiment, the rate at which metal ions can be liberated from sacrificial electrodes contained in an electrolytic reactor is increased by applying a power arrangement that makes it possible to limit current flow and allow pulsed DC power to be effectively and efficiently be applied to the cell. In an example embodiment, the disclosed system is able to prevent passivation or coating of the electrodes with contaminants by reducing heat generated in a reactor and applying a pulsed charge at selectable frequencies that effectively prevents passivation and assists in the removal of contaminants already attached to the surface of electrodes.

In an example embodiment, the pulsed charging mechanism disclosed herein may be configured using off the shelf power supplies and industry standard components. In an example embodiment, electrolytic reactors are capable of increasing the production of gas such as hydrogen as a result of improved operating efficiency through power conservation.

Additional features and advantages of the disclosed system are described in, and will be apparent from, the following Detailed Description and the Figures.

### BRIEF DESCRIPTION OF THE FIGURES

FIG. 1 is a block diagram of an example power supply arrangement, according to an example embodiment of the present disclosure.

FIG. 2 is a block diagram of an example switch arrangement, according to an example embodiment of the present disclosure.

FIG. 3 is a block diagram of an example switch arrangement, according to an example embodiment of the present disclosure.

FIG. 4 is a timing diagram of an example switch arrangement output, according to an example embodiment of the present disclosure.

FIG. 5 is a block diagram of an example power supply arrangement, according to an example embodiment of the present disclosure.

FIG. 6 is a block diagram of an example power supply arrangement, according to an example embodiment of the present disclosure.

FIG. 7 is a block diagram of an example power supply arrangement, according to an example embodiment of the present disclosure.

### DETAILED DESCRIPTION OF EXAMPLE EMBODIMENTS

As noted above, power supply arrangements, particularly for electrolytic reactors and the like, remain inefficient due to high power consumption and high maintenance. There currently is not a power source arranged to provide power in a highly efficient manner, which the reactor completely or nearly completely utilizes the power. An improved system configuration and method of supplying power to fluid treatment reactors is therefore highly desirable.

A number of different methods have been developed and applied over the years to decrease energy consumption, increase treatment capacity, and to prevent passivation and scaling of electrodes. Most of these improvements have involved mechanical alterations such as increasing the size of the reactor, using different electrode arrangements, spacing electrodes further apart to limit current flow, among several other attempted improvements. Other methods have included using variable voltage controllers to regulate or limit electrical current to the reactor, reversing the polarity of the electrodes in order to reduce coating or passivation of the electrode surface, or using multiple intermediate electrodes to reduce power requirements for increased throughput. These techniques are well known in the art; however, they offer only marginal non-sustainable improvements. As disclosed herein, in an example embodiment, an improved power arrangement may replace traditional DC power sources and have the ability to maintain the required voltage, while providing precise control over current, reducing power consumption, eliminating or reducing scaling and electrode passivation, increasing reactor throughput, and boosting overall performance.

A problem with traditional DC power supplies is they are designed to provide power to a resistive load, which typically cannot be efficiently utilized by an electrolytic reactor. In many cases, an electrolytic reactor requires less electrical current to operate than what traditional DC power arrangements provide. Traditional DC power arrangements require the voltage to be adjusted in order to control or limit the flow of electrical current. Therefore, in order for a previous power arrangement to maintain the voltage required for treatment, additional electrical current that is not beneficial to the treatment process will flow into the reactor and subsequently becomes wasted energy that is most often converted to heat. This wasted energy increases the cost of treatment by consuming more power than necessary and increasing maintenance costs as excess current will generate thermal energy, which increases the probability of electrodes collecting scale. Examples of traditional DC power arrangements include a variable AC voltage controller with a rectified DC output, which requires the AC voltage to be adjusted in order to control or limit current. Another example is the use of multiple semi-conductor relays or SCR's, which are arranged to rectify incoming AC power into DC current and also provide solid state polarity reversing on the output side of the device, however, voltage must be adjusted to provide current control. Power transformers with current limit capabilities have been used, but still rely on voltage adjustment to control current, which can hinder treatment and can be costly and cumbersome for larger treatment applications.

Additionally, traditional DC power arrangements do not provide an efficient means of processing highly conductive liquids due to the lower electrical resistance. A low electrical resistance can increase the flow of current several times beyond that which is required to operate the reactor, therefore, a means of controlling current is often necessary. However, many reactors have a specific voltage requirement that must be maintained, which prevents the use of voltage adjustment in order to control or limit current. Transformers with current limit capabilities have been used, but require customizing to provide a higher initial voltage output that would then allow voltage to be reduced to the required operating range in order to limit the flow of current to a reasonable range. However, custom transformers can require a large footprint, are expensive, require precise calculations when sizing, and furthermore, do not work effectively when treating a liquid source that has a significant variance in conductivity. Another alternative would be to modify the reactor itself or provide a reactor having electrodes arranged to provide increased electrical resistance, however, the size of the cell would be increased significantly to provide a matching throughput and still consume more energy than required for treatment. As disclosed herein, in an example embodiment, a simplified and easy to control power arrangement that allows electrolytic reactors to treat highly conductive liquids while maintaining the required voltage and current is provided.

Aside from the difficulty of processing highly conductive liquids, traditional DC power arrangements also make it difficult for electrolytic reactors to treat liquids that are relatively low in conductivity as the higher resistance between electrodes often prohibits the necessary amount of current flow to provide a sufficient reaction. As an example, a reactor designed for electrocoagulation and containing consumable metal electrodes spaced ⅛ of an inch or greater typically will not liberate metal ions required for treatment into liquid having conductivity less than 150 μS using a traditional power arrangement. In many cases, the operator is required to add electrolyte to the liquid in order to decrease resistance and provide sufficient current flow for treatment. This presents a problem for many industrial applications as some liquids contain trace levels of contaminants that must be treated and removed, but the low conductivity of the liquid does not allow enough current flow for a reaction to take place. Custom reactors having closely spaced electrodes could be constructed for a limited few applications to decrease resistance, but this would also increase input filtration requirements and make it difficult for prior art power arrangements to regulate power as the conductivity of the liquid may fluctuate, and present the potential of shorting electrodes as precipitated solids may reside or become trapped in the reactor. As disclosed herein, in an example embodiment, a power assembly capable of treating liquids having virtually any measure of conductivity and without requiring the addition of electrolyte is provided.

Additionally, in an example embodiment, a practical method of increasing the amount of metal ions liberated from electrodes using electrolytic reactors arranged for electrocoagulation or electrochemical metal ion generation is disclosed herein. Increasing the rate at which metal ions are introduced to the liquid will increase throughput of the reactor and improve treatment performance. The only practical way to liberate more metal ions using a traditional power arrangement is to increase voltage and surface area of the electrodes, or increasing surface area by adding additional electrodes. Increasing the voltage also increases the flow of unnecessary current and can generate too much thermal energy, therefore, providing an inefficient method of increasing the production of metal ions. It has been found that providing a pulsed charge to a submerged metal surface will increase the rate at which metal ions are liberated. This would be the preferred method of increasing metal ion production; however, traditional power arrangements do not offer an effective way to limit current flow to the reactor while providing a pulsed charge, especially when processing highly conductive solutions. Thus, reactors of this type in the prior art have been limited in their applications. As disclosed herein, in an example embodiment, an efficient and practical means of increasing the rate of which metal ions are liberated is provided for fluid treatment reactors of this type.

Many liquids contain contaminants such as calcium, magnesium, and emulsified oils that subject electrodes to passivation or scaling. As a result, the electrodes must be cleaned and sometimes replaced entirely. Much research has been performed to find a way to eliminate anodic or cathodic passivation. It has been found that when current density is increased in an electrolytic reactor, polarity reversing must be applied at reduced intervals to extend the operational time of electrolytic reactors to delay complete passivation. Automatic cleaning measures typically include use of a series of pumps, tanks, and valves that periodically fill the reactor with acid to dissolve the debris from the electrodes. This method works, but it requires additional space, dissolves valuable electrode material, is expensive to construct, prohibits treatment during cleaning cycles, and requires additional engineering requirements that may limit the commercial viability of certain electrolytic devices. There are various known methods of reducing and managing problems with electrodes becoming coated with contaminants, but an improved method is highly desirable. As disclosed herein, a better method of providing power that may prevent or reduce scaling or passivation of the electrodes without interrupting treatment, and also having the ability to remove any pre-existing scale from reactors, is provided with an example embodiment of a power supply arrangement of a fluid treatment reactor.

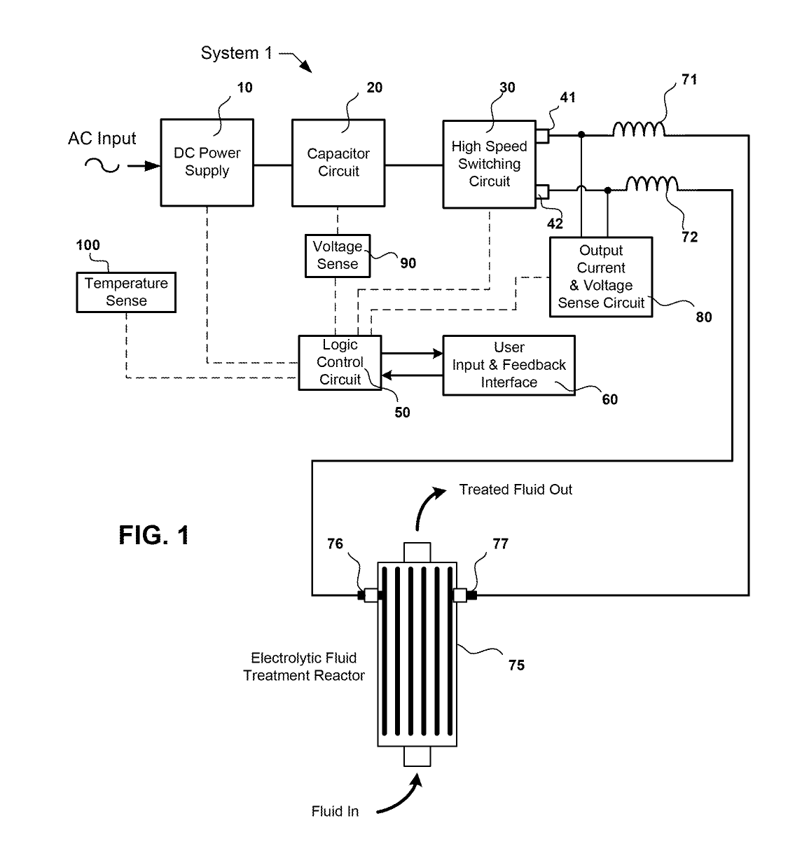

A block diagram of an example power arrangement of system 1 is illustrated in FIG. 1. The illustrated exemplary system 1 includes a DC power supply 10, a capacitor circuit 20, a high speed switching circuit 30 with outputs 41 and 42, a logic control circuit 50, a user input and feedback interface 60, inductors 71 and 72, electrolytic fluid treatment reactor 75 with electrodes 76 and 77, output current and voltage sense circuit 80, voltage sense 90, and temperature sense 100. As illustrated, AC power is applied to the DC power supply 10. The DC power supply 10 includes an automatic current limiting feature, whereby the DC output provides continuous charging of the capacitor circuit 20 at a regulated rate to prevent excess current draw. It should be appreciated that the DC output typically may provide continuous charging of the capacitor circuit 20, but charging may not occur continuously at all times, for example, if an interruption occurs. The capacitor circuit 20 includes at least one capacitor with high capacity storage of the power supplied from the DC power supply 10. Upon startup, sufficient time is initially provided for the capacitor circuit 20 to reach full charge prior to activating the high speed switching circuit 30. The high speed switching circuit 30 may include an H-bridge circuit with at least four high power insulated gate bipolar transistors with reversible pulsed outputs 41, 42 capable of synchronized on and off operation at a selectable low to high frequency range. It should be appreciated that other switches, such as MOSFETs, may be used in the high speed switching circuit 30.

The logic control circuit 50 communicates with the high speed switching circuit 30, enabling the high speed switching circuit 30 to turn on and off at the desired frequency, polarity, and duty cycle according to input provided at the user input and feedback interface 60. The user input and feedback interface 60 enables the operator to monitor the status of the power arrangement such as output voltage, amperage, and polarity, while also allowing the operator to manually set the various functions of the logic control circuit 50, including polarity position, timed polarity switching intervals, frequency, and duty cycle of the high speed switching circuit 30. The frequency and duty cycle of the supplied train of pulses from the high speed switching circuit 30 are adjusted according to the desired current and voltage to be applied to the reactor 75. Typically, as a conductivity of a fluid to be treated increases, a lower duty cycle may be employed, and as a conductivity of a fluid decreases, a higher duty cycle may be employed.

One or more inductors 71, 72 may be provided on the output of the high speed switch circuit 30 and may include any inductive means such as coiling the output wire or simply providing close spacing of the pair of output wires being supplied from the high speed switching circuit 30 to the electrolytic reactor 75. It is well known in the art that pulsing electrical current through an inductor is an effective means of limiting electrical current. In this example embodiment, inductance is provided using two inductors 71, 72 located at each of the two outputs 41, 42 for limiting current, while maintaining the desired voltage potential to the electrodes 76, 77 required for operating the electrolytic reactor 75. The size of the electrolytic reactor 75, including electrode size, electrode spacing, current density requirement, and electrical resistance due to the conductivity of the fluid within the reactor 75 will dictate the amount of inductance necessary, in addition to the frequency and duty cycle of the high speed switching circuit 30 to achieve the desired power for operating the electrolytic reactor 75. The output voltage and current sense circuit 80 detects the amperage and voltage at the outputs 41, 42 of the power supply. The operator may adjust the frequency and duty cycle of the high speed switching circuit 30 to increase or decrease power output as desired using the user input and feedback interface 60.

The voltage sense circuit 90 provides feedback to the logic control circuit 50 for monitoring the level of charge stored in the capacitor circuit 20. If the voltage of the capacitor circuit 20 drops below the desired voltage range, the operator may adjust the frequency or duty cycle settings of the high speed switching circuit 30 using the user input and feedback interface 60 to reduce the output power being supplied to the reactor 75. The power supply system 1 can be operated by manually selecting the desired frequency and duty cycle of the high speed switching circuit 30 or by enabling the control logic circuit 50 to automatically adjust the frequency and duty cycle of the high speed switching circuit 30 to maintain the desired or optimal power settings provided by the operator at the user input and feedback interface 60. The power supply arrangement illustrated in system 1 allows automated polarity reversal based on feedback from the voltage sense and current sense input into the logic control circuit 50. Scaling of electrodes 76, 77 interferes with current transfer and is detected by the logic control circuit 50 as the output current and voltage sense circuit 80 drops below the desired output current setting. The logic control circuit 50 can be configured to automatically reverse the polarity of the outputs 41, 42 if output current falls below the desired input value. In addition, cleaning of electrodes 76, 77 can be performed by switching the polarity of the outputs 41, 42 at high speeds to provide an alternating DC pulsed output at high frequency, which is effective for removing scaling from the surface of electrodes 76, 77 contained within an electrolytic cell of the reactor 75.

The temperature sense 100 may be applied to a heat sink or the like to monitor the temperature of one or more components, for example, including the high speed switching circuit 30 and the capacitor circuit 20. For example, control logic circuit 50 may automatically adjust the duty cycle if an overheat condition arises, and/or an alarm may be indicated on the user input and feedback interface 60.

Providing a pulsed charge has also been found to increase the rate at which metal ions can be liberated from metal electrodes 76, 77. In certain reactor applications, such as a reactor 75 arranged with metal electrodes 76, 77 for electrocoagulative treatment of liquids, it is desired to increase the release of metal ions from electrodes 76, 77 contained within the reactor 75. Increasing the rate at which metal ions are liberated allows liquid flow to be increased through a reactor 75, thereby, reducing the size of the reactor 75 or making it possible to address larger liquid treatment applications. It should be appreciated that the electrodes 76, 77 may be consumable electrodes (e.g., steel, iron, or aluminum electrodes) or non-consumable electrodes (e.g., platinized titanium electrodes). In an example embodiment, the electrodes 76, 77 may be permanent non-consumable electrodes, and replaceable intermediate electrodes may be placed between the permanent non-consumable electrodes 76, 77.

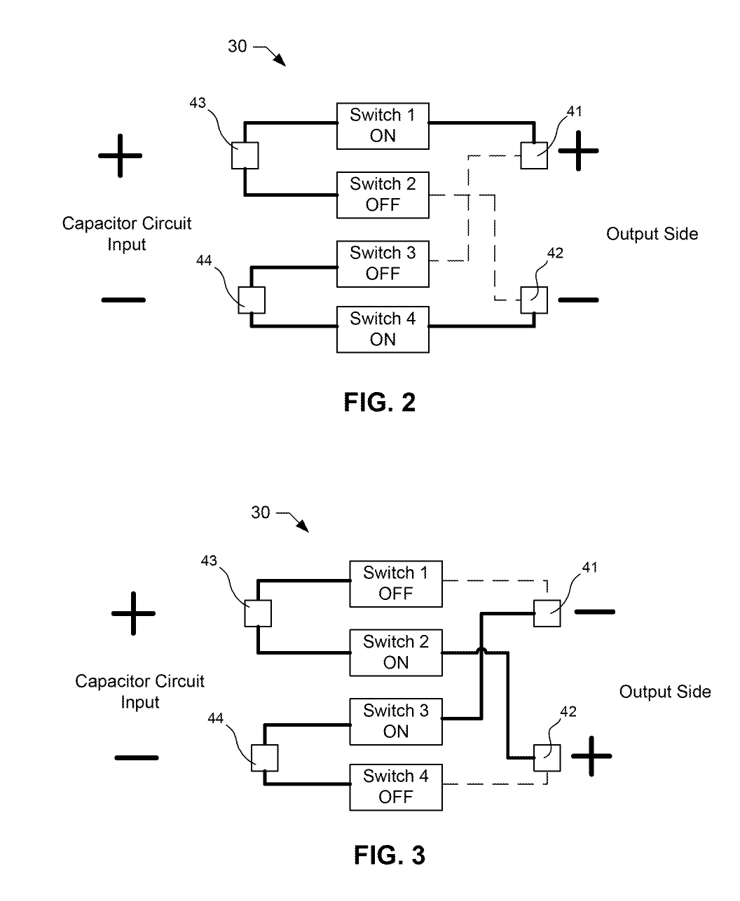

FIGS. 2 and 3 are block diagrams of an example switch arrangement, illustrating the polarity reversal function of the high speed switching circuit 30. FIG. 2 shows switch 1 and switch 4 in the ON position for providing pulsed forward polarity of the high speed switching circuit 30. The high speed switching circuit 30 has inputs 43, 44 that are connected to the capacitor circuit 20, which are connected with switches 1 to 4. The switches 1 to 4 are connected to the outputs 41, 42, with the solid lines from switch 1 to output 41 and from switch 4 to output 42 providing an output voltage on the output side of the high speed switching circuit 30, and allowing for a current flow from the capacitor circuit 20.

FIG. 3 shows the polarity reverse switch in reverse mode, as switch 1 and switch 4 are in the steady OFF position with switch 2 and switch 3 in the ON position. The switches 2 and 3 are connected to the outputs 41, 42, with the solid lines from switch 2 to output 42 and from switch 3 to output 41 providing a reversed polarity output voltage on the output side of the high speed switching circuit 30.

As previously explained, in FIGS. 2 and 3, the switches in the ON position complete the circuit through the electrolytic reactor and permit current flow as the ON switches are pulsed on and off in the hertz to kilohertz range, while the switches in the OFF position remain in a steady OFF state, as indicated by the dotted lines. The output side of the high speed switching circuit 30 can accordingly provide either polarity and may reverse polarity based on the state of switches 1 to 4.

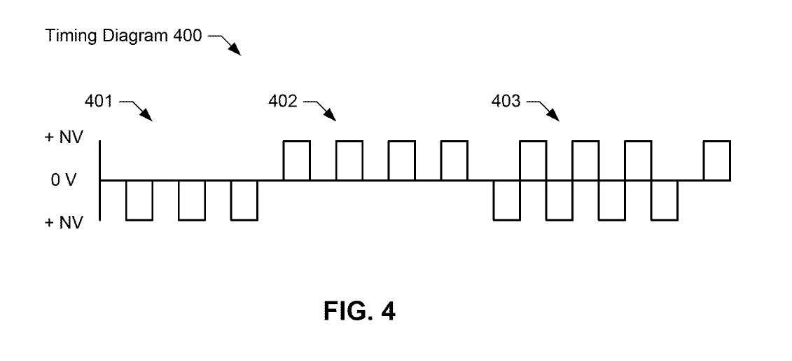

FIG. 4 is a timing diagram 400 of an example switch arrangement output, which illustrates the various possibilities of output signals as provided by the system 1. The scale of drawing shows exemplary pulses at a 50% duty cycle and shows how pulses are applied to the reactor 75. The reactor 75 may be subjected to a series of forward polarity pulses 402, a series of reverse polarity pulses 403, or a combination of both forward and reverse polarity alternating pulses 403 at a desired frequency. It should be appreciated that, although the timing diagram 400 only shows a few pulses, that the forward polarity pulses 402 and reverse polarity pulses 401 would typically be employed for many more cycles than as illustrated in FIG. 4. Moreover, any suitable duty cycle, polarity interval, and frequency may be applied to a reactor 75, and the specific values may very greatly depending on each particular application. In an example embodiment, a frequency of 20 kilohertz at a duty cycle of 20% may be applied to the reactor 75, with polarity reversal occurring every 15 minutes. In an example embodiment, a frequency of 10 kilohertz at a duty cycle of 50% with polarity reversing every 1 millisecond or every 30 seconds may be employed. The power supply arrangement of system 1 makes it possible to provide multiple different pulsing arrangements as required by various electrolytic applications.

In an example embodiment, the polarity reverses if the output current decreases below a certain level. Accordingly, an even wear-off and scaling of electrodes may occur. For example, if the polarity reversal is set for five minutes, the polarity may automatically reverse at four minutes if the current level drops to below a predetermined level at four minutes. In an example embodiment, there is a polarity reversal in a successively alternating fashion, as illustrated at alternating pulses 403, which cleans the electrodes 76, 77 of the reactor 75.

The presently disclosed power supply arrangement may provide power to individual reactors 75, or multiple reactors connected in series or parallel to the outputs 41, 42. The size of the system 1 can be incrementally increased or decreased in size for providing power to reactors 75 of any size.

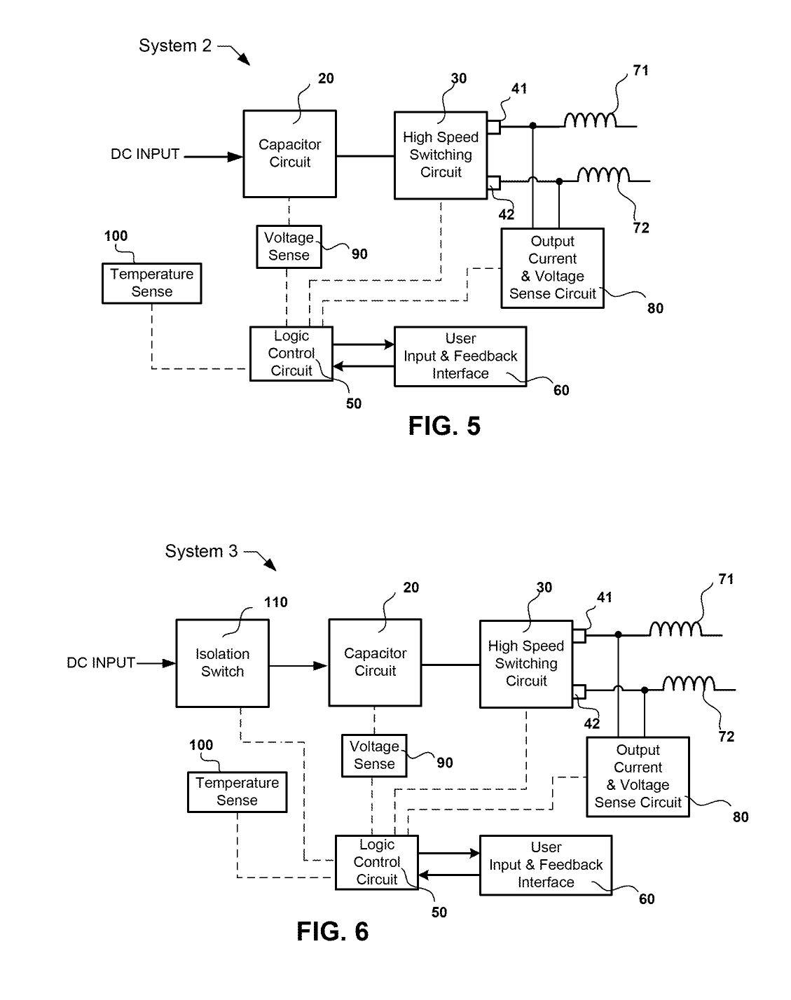

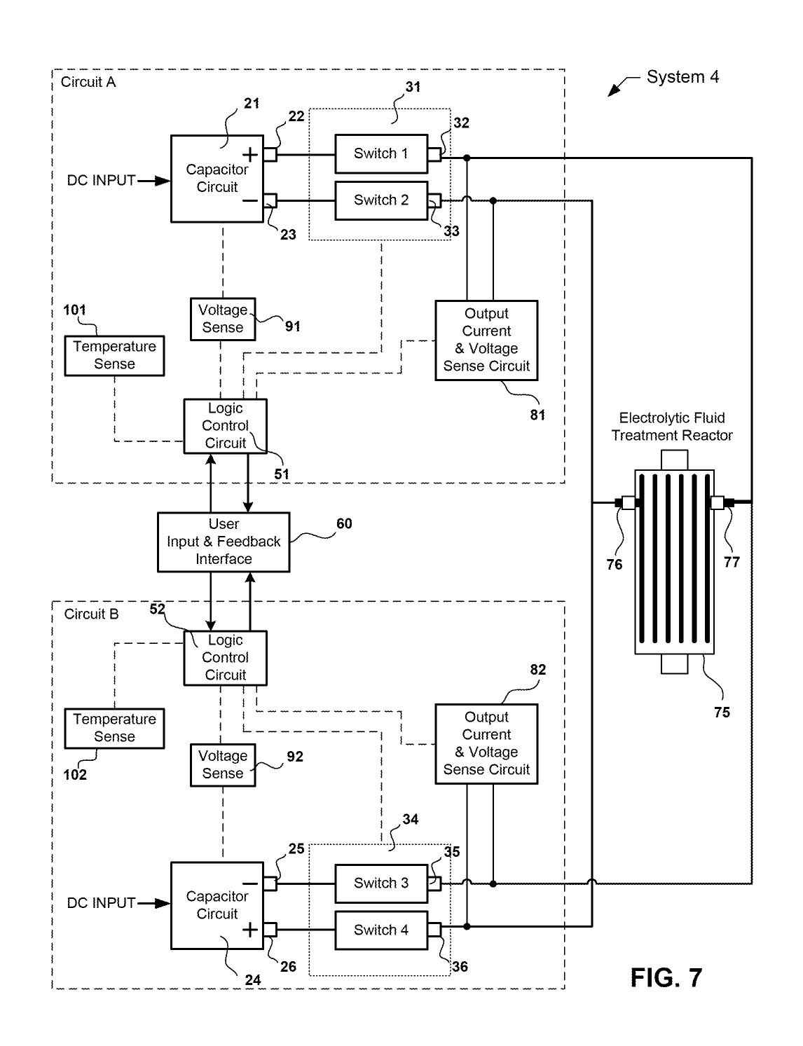

FIG. 5 is a block diagram of an example power supply arrangement illustrated as system 2. It should be appreciated that the reference numerals used for FIG. 1 that are common to components of FIG. 5, as well as FIGS. 6 and 7 discussed below, may be used throughout this disclosure. Accordingly, each reference numeral of FIGS. 5 to 7 may be described above and may not be specifically described further unless necessary. Using this exemplary arrangement of system 2, an external DC power source is used to apply power to capacitor circuit 20, which through high speed switching circuit 30 provides a capacitive pulsed discharge, while also providing automatic polarity reversal. Typically, an installation may require that the DC power supply is installed separately from the rest of the power supply circuit components, although this is not required. The power supply of system 2 also provides a way to upgrade or retrofit an existing DC power supply with capacitive pulsed discharge by connecting the capacitor circuit 20 directly to the outputs of an existing DC power source. In an example embodiment, the capacitor circuit 20 and the high speed switching circuit 30 may be housed in a single compartment which may allow for easy installation. For example, a portable housing may be brought to an existing fluid treatment reactor facility and installed with existing DC power supplies 10 and existing reactors 75, for example, as a black box installation.

FIG. 6 is a block diagram of an example power supply arrangement illustrated as system 3. System 3 includes an isolation switch 110 that receives the DC input and provides the DC power to the capacitor circuit 20. An isolation switch 110 may be used where it is desirable to be able to completely isolate the DC power input. Such a configuration may be particularly advantageous if no power is required to a reactor for an extended period of time. The isolation switch 110 can be a manual type switch or may be electrically actuated to be opened and closed by the logic control circuit 50 for automatic control.

FIG. 7 is a block diagram of an example power supply arrangement illustrated as system 4, which includes two separate capacitive charging power circuits A and B. Circuit A and circuit B both have non-reversing switching circuits 31, 34. Non-reversing switching circuit 31 includes switch 1 and switch 2, which have outputs 32 and 33, respectively. Non-reversing switching circuit 34 includes switch 3 and switch 4, which have outputs 35 and 36, respectively. Non-reversing switching circuit 31, 34 may include high speed switches such as high speed semiconductor switches. It should be appreciated that a high speed switch could include mechanical means such as contactors, and that contactors and other rotary switches could be used at low frequencies in the Hertz range.

As illustrated, the components of circuit A and circuit B may be congruently arranged to interact with user input and feedback interface 60 and logic control circuits 51, 52. Logic control circuits 51, 52 interact with temperature sense 101, 102, voltage sense 91, 92, output current and voltage sense circuit 81, 82, and non-reversing switching circuits 31, 34. Voltage sense 91, 92 reads the voltages capacitor circuits 21, 24. Capacitor circuit 21 includes positive output 22, which connects to switch 1, and negative output 23, which connects to switch 2. Capacitor circuit 24 includes negative output 25, which connects to switch 3, and positive output 26, which connects to switch 4. Accordingly, the polarities of capacitor circuit 21 and capacitor circuit 22 are reversed. The positive output 32 of switch 1 and the negative output 35 of switch 3 are connected to electrode 77, while the negative output 33 of switch 2 and the positive output 36 of switch 4 are connected to electrode 76. Thus, the polarity seen by the reactor 75 reverses when the non-reversing switching circuits 31, 34 are alternately turned on.

In this example embodiment, both circuits A and B are turned on and off simultaneously, such that only one circuit is on while the other is off to provide polarity reversal as opposed to using, for example, a single high speed switching circuit 30, containing four separate switches for alternating the output polarity. In this example embodiment, it may be preferred to use only one user input and feedback interface 60 in order to provide precise on and off timing between both circuits. Also, in the example embodiment of system 4, there is no inductive load between the outputs 32, 33, 35, 36 and the electrodes 76, 77. It should be appreciated that an inductive load may or may not be necessary depending on the size of a reactor, fluid conductivity, power requirements, and the like.

An example embodiment of the disclosure may include supplying power to an electrocoagulation reactor for treating water produced from a natural gas mining operation. This example embodiment may be made with reference to FIG. 1. For example, treatment is provided for highly conductive saltwater having 650,000 microsiemens conductivity, which is roughly nine times the conductivity of sea water. A flow-through electrocoagulation reactor 75 selected may be sized to provide 10 gallons per minute of treatment and include sixteen cold rolled steel electrode plates each measuring 12 inches wide by 48 inches long by ⅛ inch thick and spaced roughly ⅛ inch apart inside a plastic rectangular housing with the outermost two electrodes 76, 77 being the terminal electrodes for connecting to the DC power outputs 41, 42. For example, the minimum voltage at the two terminal electrodes 76, 77 for electrocoagulation to occur may be at least 19.5 volts to ensure 1.3 volts is maintained between each of the electrode plates placed in series between the connected terminal electrodes 76, 77. A 240V AC power source may provide the input power to a regulated 48V DC, 4800 watt power supply 10 with a 4,800 watt output capacity. A variety of other regulated and non-regulated DC power options may be used for the DC power supply 10, however a regulated DC power supply 10 may be used as a convenient off the shelf DC option with a current limit feature for restricting current inrush on initial charge of the capacitor circuit. AC power may be turned on using a switch to supply power to the DC power supply 10, in turn, charging the capacitor circuit 20 consisting of three 16.2 volt capacitors wired in series to provide a storage capacity of 19.33 Farads at 48.6 Volts. The high speed switching output 30 may include two half bridge IGBT (insulated gate bipolar transistor) power modules with a driver board for operating each of the power modules, which may be available from multiple semiconductor products manufactures and electronics suppliers. The outputs of the half bridge power modules are coupled together to create an H-bridge circuit, resulting in two independently controlled high speed output terminals 41, 42 with opposing polarities.

For example, an output current and voltage sense circuit 80 may include of a pair of Hall Effect current sensors and a simple shunt with a filtering capacitor for monitoring power output. A temperature sensor 100 may be placed on a heat sink to monitor the temperature and avoid overheating. For example, a desktop computer may provide the user input and feedback interface 60 and be connected by cable to the logic control circuit 50 including an off the shelf PLC (programmable logic controller) to monitor and make program adjustments until the desired performance is achieved. Upon initial charging of the capacitor circuit 20 the voltage sense 90 enables the logic control circuit 50 to determine that the voltage is suitable to start the system. A signal provided by the user input and feedback interface 60 enables the logic control circuit 50 to turn on the selected half bridge IGBT power modules of the high speed switching output 30. For example, based on a particular size reactor and water conductivity, the on time may be set to 24 microseconds, representing a 30 percent duty cycle at an operating frequency of 12.5 kilohertz and a polarity reversal being applied once every 5 minutes, which may be optimal for maintaining the minimum voltage potential and preventing or reducing scale buildup on the surface of the electrodes 76, 77. Increasing the duty cycle above 30 percent may result in higher amperage draw and reduced voltage output. Decreasing the duty cycle below 5 percent may result in lowered voltage output below the minimum voltage required by the reactor 75 to operate. For example, the inductors 71, 72 may be provided by the cables leading to the reactor 75. For example, if the distance of cable was five feet, merely tying the two cables together for most of this distance may provide sufficient inductance to prevent the current at each pulse from spiking beyond the rated current of the high speed switching output 30. Inductors 71, 72 are not always required, for example, for smaller applications or when treating less conductive water, however, larger applications might require the use of coiled inductors to be placed on the outputs 41, 42 if the low resistance of the reactor 75 is expected to draw more current than desired. The amperage output to the reactor 75 may be, for example, 600 amps for each pulse, which can be well below a peak pulsed current rating of the example IGBT half bridge power modules. For example, even with a 600 amp pulse output from high speed switching circuit 30, the AC line amperage before the DC power supply 10 may register only 13.8 amps for a total of 3,312 watts power consumption. Furthermore, there may be no change in the temperature between the source water entering the reactor 75 and the treated water exiting the reactor 75. Accordingly, the pulsed charge to the reactor 75 may provide a much more efficient way of providing power to a reactor 75 than merely supplying steady DC power from a traditional power source.

In an example embodiment, during operation, the voltage of the capacitor circuit 20 may be monitored to ensure sufficient time is provided between each pulse to allow the capacitor circuit 20 to fully charge and maintain the minimum required voltage potential. If the capacitor circuit 20 does not reach the minimum voltage, a low voltage signal from the voltage sense 90 may trigger an alarm at the logic control circuit 50 and either automatically decrease the pulse width of the high speed switching output 30 or cease supplying power to the reactor 75 by turning off the high speed switching output 30. The output current and voltage sense circuit 80 may be required to be within a specific voltage and current range and be monitored by the logic control circuit 50 to ensure power to the reactor 75 is sufficient and also prevent exceeding current ratings of the electronics components. Also, exceeding the desired temperature as indicated by the temperature sensor 100 would also cause the logic control circuit 50 to either decrease the pulse width of the high speed switching output 30 to limit the excess current draw causing the heat or to stop current flow entirely by turning off the high speed switching output 30. This example embodiment of the disclosed power supply may be limited to basic functionality. For example, the system may stop and sound an alarm when feedback to the logic control circuit 50 is out of range, or may be completely automatic involving programming the logic control circuit 50 to automatically adjust the operation of each of the components until all feedback values are within range. The level of automation, in addition to the type and size of components necessary may be determined on a per application basis.

In an example embodiment, a power supply arrangement as disclosed herein may prevent or reduce the occurrence of component failure and prevent or reduce circuit breaker tripping, while also reducing power consumption and passivation and scaling of electrodes. Accordingly, improved efficiency of power supply for fluid treatment applications and the like may be advantageously achieved.

It will be appreciated that all of the disclosed systems, configurations, procedures, and methods described herein can be implemented using one or more computer programs or components. These components may be provided as a series of computer instructions on any conventional computer readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. Also, it should be appreciated that the features of the dependent claims may be embodied in each of the independent claims.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. It is anticipated that one or more members of a group can be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein can be further limited in the claims using consisting of or and consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

In closing, it is to be understood that the embodiments of the invention disclosed herein are illustrative of the principles of the present invention. Other modifications that can be employed are within the scope of the invention. Thus, by way of example, but not of limitation, alternative configurations of the present invention can be utilized in accordance with the teachings herein. Accordingly, the present invention is not limited to that precisely as shown and described.

The invention is claimed as follows:

1. A system comprising:
a DC power source that receives an AC input;
a capacitor circuit configured to store energy that is continuously charged from the DC power source;
a high speed switching circuit including an input connected to the capacitor circuit, the high speed switching circuit configured as an H-bridge with reversing polarity outputs configured to provide a pulsed discharge of energy at a frequency having an adjustable duty cycle;
an inductive load connected to the reversing polarity outputs, and
a fluid treatment reactor, the reactor including at least two electrodes connected to the inductive load.

2. The system of claim 1, wherein fluid treatment reactor is at least one of an electrolytic reactor and an electrochemical reactor for at least one of electrocoagulative treatment of fluids, continuous generation of metal ions from sacrificial electrode members, deionization, capacitive deionization, electrolytic oxidation, and electrodialysis.

3. The system of claim 1, wherein the high speed switching circuit includes two half bridge IGBT power modules and two driver boards for operating each respective half bridge IGBT power module.

4. The system of claim 1, wherein the pulsed discharge of energy is provided in a duty cycle of 1% to 80%.

5. The system of claim 1, wherein the pulsed discharge of energy is provided in a duty cycle of 1% to 30%.

6. The system of claim 1, wherein the pulsed discharge of energy is provided in a frequency range of less than 5 kHz.

7. The system of claim 1, wherein the pulsed discharge of energy is provided in a frequency range of 5 kHz to 20 kHz.

8. The system of claim 1, wherein the pulsed discharge of energy is provided in a frequency range of greater than 20 kHz.

9. The system of claim 1, wherein the pulsed discharge of energy is provided in a first polarity continuously for a first time period and successively provided in a second polarity continuously for a second time period, wherein a polarity reversal between the first polarity and the second polarity occurs every 30 seconds to every 60 minutes.

10. The system of claim 1, wherein the pulsed discharge of energy is provided in a frequency range of 12.5 kHz, with a duty cycle of 30%, and in a first polarity continuously for a first time period and successively provided in a second polarity continuously for a second time period, wherein a polarity reversal between the first polarity and the second polarity occurs every 5 minutes.

11. The system of claim 1, wherein the pulsed discharge of energy is provided in a first polarity and a second polarity as a successively alternating polarity reversal between the first polarity and the second polarity for a period of time.

12. The system of claim 1, wherein the inductive load includes two substantially untwisted wires connecting the reversing polarity outputs to the electrodes of the fluid treatment reactor.

13. The system of claim 1, wherein the inductive load includes at least one inductor.

14. The system of claim 1, wherein the fluid treatment reactor is configured to treat fluids that have less than 1,000 microsiemens conductivity.

15. The system of claim 1, wherein the fluid treatment reactor is configured to treat fluids that have a range of 5,000 to 50,000 microsiemens conductivity.

16. The system of claim 1, wherein the fluid treatment reactor is configured to treat fluids that have a range of 50,000 to 650,000 microsiemens conductivity.

17. The system of claim 1, wherein the fluid treatment reactor is configured to treat fluids that have at least 650,000 microsiemens conductivity.

18. The system of claim 1, wherein the fluid treatment reactor is configured to perform at least one of sodium hypochlorite generation and ferrate ion generation.

19. A power source for electrolytic and electrochemical reactors, comprising:
a capacitor circuit configured to store energy that is charged by a DC power source;
at least one switching circuit including independently controlled reversed polarity outputs configured to provide a pulsed discharge of energy from the capacitor circuit at a frequency having an adjustable duty cycle to a fluid treatment reactor including at least two electrodes for at least one of electrolytic and electrochemical fluid treatment.

20. A method for supplying power to electrolytic and electrochemical reactors, comprising:
charging a capacitor circuit configured to store energy with a DC power source;
switching reversed polarity outputs to:
provide a first pulsed discharge of energy from the capacitor circuit at a frequency having a first duty cycle to a fluid treatment reactor including at least two electrodes for at least one of electrolytic and electrochemical fluid treatment; and
provide a second pulsed discharge of energy from the capacitor circuit at the frequency having a second duty cycle different from the first duty cycle to the fluid treatment reactor.
